(19) United States
(12) Patent Application Publication
(10) Pub. No.: US 2014/0085280 A1
(43) Pub. Date: Mar. 27, 2014

(54) DISPLAY CONTROL DEVICE AND CONTROL METHOD THEREFOR, AND DISPLAY SYSTEM

(71) Applicant: SHARP KABUSHIKI KAISHA, Osaka-shi, Osaka (JP)

(72) Inventors: Kohji Saitoh, Osaka-shi (JP); Asahi Yamato, Osaka-shi (JP); Masami Ozaki, Osaka-shi (JP); Toshihiro Yanagi, Osaka-shi (JP)

(73) Assignee: SHARP KABUSHIKI KAISHA, Osaka-shi, Osaka (JP)

(21) Appl. No.: 14/119,486

(22) PCT Filed: May 24, 2012
(86) PCT No.: PCT/JP2012/063381

§ 371 Date: Nov. 22, 2013

(30) Foreign Application Priority Data
May 27, 2011 (JP) 2011-119777

(51) Int. Cl. G09G 5/00

(52) U.S. Cl. CPC G09G 5/00
USPC 345/204

(57) ABSTRACT

A timing controller (7) controls a display module (2) which carries out a scanning process to display a picture based on a picture signal. The timing controller (7) is configured such that when a display signal reception section (20) no longer receives the picture signal, an operation determination section (21) determines the scanning process should be paused, and a timing generation section (22) instructs drive circuits (4, 5) to pause the scanning process in a display panel (2a).

### TECHNICAL FIELD

The present invention relates to a display control device that controls a display module which displays images by carrying out a scanning process in which image signals are converted into images, a method in which such a display control device controls such a display module, and a display system.

### BACKGROUND ART

In general, a display system includes: a display module; and a display control device that controls the display module. The display module includes: a matrix display element whose display pixels are arranged in a matrix manner; and a drive circuit that drives the display element.

The matrix display element is used in an FPD (flat-panel display) such as an LCD (liquid crystal display), a PDP (plasma display panel), or an EL (electroluminescence) display. FPDs have recently been used in a large number of display devices as FPDs can be made thinner and lighter than conventional CRTs (cathode-ray tubes).

Meanwhile, the display control device transmits, to the drive circuit of the display module, image signals and various control signals in accordance with which the display element is driven. This causes the display element of the display module to carry out a scanning process in which the image signals are converted into images, so that the images are displayed.

Since a conventional display device operates in a continuous fashion, it consumes a large amount of electric power. In order to solve this problem, Patent Literatures 1 to 4, for example, propose display devices that operate in an intermittent fashion.

The display device 1 of Patent Literature 1 has scanning and non-scanning periods set therefor, and during a non-scanning period, a control IC prevents signals other than a gate start pulse signal from being inputted to a gate driver and a source driver. This eliminates the need to cause logic circuits inside the gate driver and the source driver to operate during the non-scanning period, thus achieving a reduction in electric power consumption.

Further, the matrix display device of Patent Literature 2 has a frame buffer built in a signal electrode drive circuit of an LCD module. In the absence of a change in display data, the display data is not transferred from a module controller to the LCD module. This achieves a reduction in electric power consumption. Further, in the presence of a change in display data, the display data is transferred with low-frequency clocks independently of liquid crystal display timings. This eliminates the need for operation with high-frequency clocks, thus achieving a further reduction in electric power consumption.

Further, the liquid crystal display device of Patent Literature 3 has a liquid crystal drive circuit which, in the absence of a video signal, stops outputting drive pulses necessary for liquid crystal display and retains an image currently displayed on an LCD panel. By thus stopping outputting the drive pulses, a reduction in electric power consumption can be achieved.

Further, the display device of Patent Literature 4 detects a frame rate and reference time of a video signal in accordance with address information added to the video signal or leading information of the video signal and, on detecting a decrease in the frame rate, requires a supply source of the video signal to reduce the transmission rate at which image signals are transmitted to the display device or to transmit a reduced number of image signals. This makes it possible to prevent so called tearing in which an ugly image is displayed due to a mixture of an image before the frame is refreshed and an image after the frame is refreshed.

### CITATION LIST

Patent Literature 1

Japanese Patent Application Publication, Tokukai, No. 2001-312253 (Publication Date: Nov. 9, 2001)

Patent Literature 2

Japanese Patent Application Publication, Tokukai, No. 2001-060079 (Publication Date: Mar. 6, 2001 )

Patent Literature 3

Japanese Patent Application Publication, Tokukaihei, No. 11-338425 (Publication Date: Dec. 10, 1999 )

Patent Literature 4

Japanese Patent Application Publication, Tokukai, No. 2003-036046 (Publication Date: Feb. 7, 2003 )

### SUMMARY OF INVENTION

### Technical Problem

A disclosure is made of the display device of Patent Literature 1 that for each type of scanning period during which a scanning process is executed, a plurality of pause periods during which the scanning process is paused can be set. Further, a disclosure is made of the liquid crystal display device of Patent Literature 3 that each of the pause periods can be set to be an integral multiple of the scanning period.

However, in setting a plurality of intermittent operations, the display control device needs to prepare, for each setting, timings of execution and pausing of a scanning process. For this reason, an increase in the number of settings leads to increases in scale and complexity of a circuit configuration in which the timings are generated.

The present invention has been made in view of the foregoing problems, and it is an object of the present invention to provide a display control device etc. capable of dealing with various intermittent operations without inviting increases in scale and complexity of a circuit configuration.

### Solution to Problem

In order to attain the foregoing object, a display control device according to the present invention is a display control device that controls a display module which carries out a scanning process to display an image based on an image signal received, in stopping transfer of the image signal to the display module, the display control device instructing the display module to pause the scanning process.

Further, in order to attain the foregoing object, a control method in which a display control device carries out control according to the present invention is a control method in which a display control device controls a display module which carries out a scanning process to display an image based on an image signal received, the control method including the step of, in stopping transfer of the image signal to the display module, instructing the display module to pause the scanning process.

According to the foregoing configuration and the method, when the transfer of received picture signals to the display module has been stopped, the display module is instructed to pause the scanning process so that the scanning process in the display module is paused. For this reason, there is no change in condition for pausing of the scanning process even if there is a change in intermittent operation. This makes it possible to deal with various intermittent operations without inviting increases in scale and complexity of a circuit configuration.

### Advantageous Effects of Invention

As described above, the display control device according to the present invention is configured such that when the transfer of received picture signals to the display module has been stopped, the display module is instructed to pause the scanning process so that the scanning process in the display module is paused. This brings about an effect of making it possible to deal with various intermittent operations without inviting increases in scale and complexity of a circuit configuration.

### BRIEF DESCRIPTION OF DRAWINGS

FIG. 1 is a block diagram showing details of a configuration of an electronic apparatus according to an embodiment of the present invention.

FIG. 2 is a block diagram showing details of configurations of a display signal transfer section and a timing controller in the electronic apparatus.

FIG. 3 is a timing chart showing examples of temporal changes in timing signals that the timing controller outputs to a scanning line drive circuit and in output signals from the scanning line drive circuit.

FIG. 4 is a set of timing charts showing examples of temporal changes in incoming picture signal, in scanning process, and in display state of the electronic apparatus.

FIG. 5 is a timing chart showing other examples of temporal changes in incoming picture signal, in scanning process, and in display state of the electronic apparatus.

FIG. 6 is a block diagram showing details of configurations of a display signal transfer section and a timing controller in an electronic apparatus according to another embodiment of the present invention.

FIG. 7 is a timing chart showing temporal changes in operating state and various signals of a display module in an electronic apparatus according to still another embodiment of the present invention.

FIG. 8 is a block diagram showing details of configurations of a display signal transfer section and a timing controller in an electronic apparatus according to still another embodiment of the present invention.

FIG. 9 is a block diagram showing details of configurations of a display signal transfer section and a timing controller in an electronic apparatus according to still another embodiment of the present invention.

FIG. 10 is a timing chart showing temporal changes in an operation determination signal and a display signal that are outputted by a display signal transfer section in an electronic apparatus according to another embodiment of the present invention.

FIG. 11 is a graph showing the characteristics of various TFTs.

### DESCRIPTION OF EMBODIMENTS

### Embodiment 1

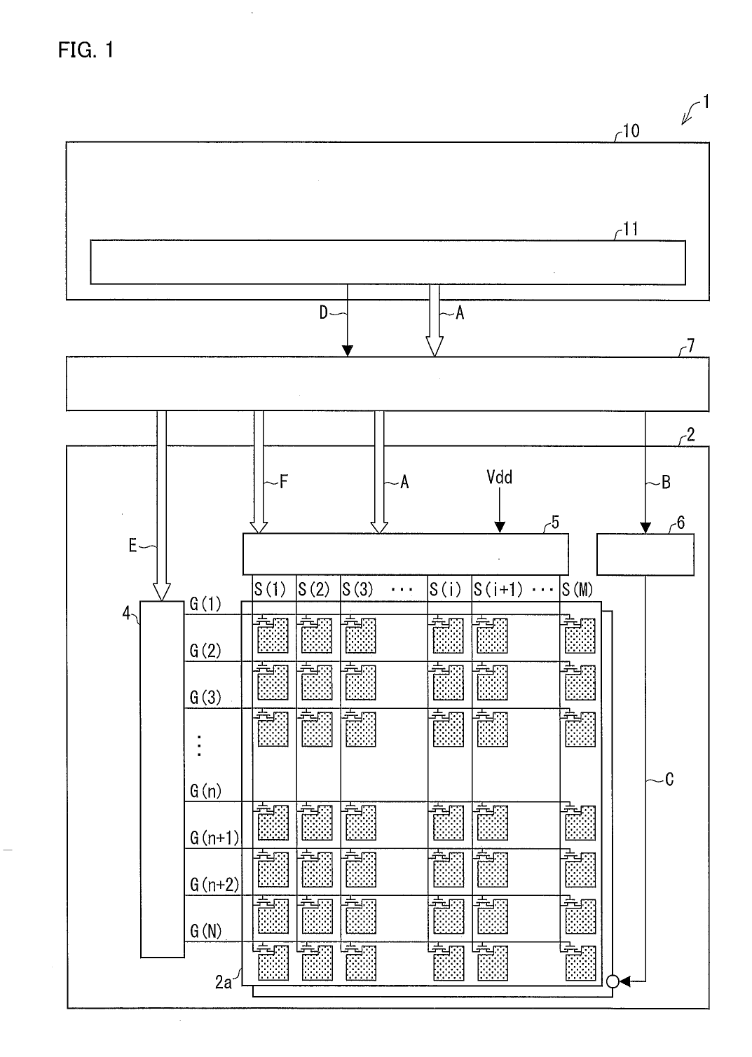

An embodiment of the present invention is described below with reference to FIGS. 1 through 5 and 11.

(Configuration of an Electronic Apparatus 1)

First, a configuration of an electronic apparatus (display system) 1 according to the present embodiment is described with reference to FIG. 1. FIG. 1 is a block diagram showing details of the configuration of the electronic apparatus 1 according to the present embodiment. Examples of the electronic apparatus 1 include mobile phones, smartphones, laptop personal computers, various tablet information terminal apparatuses, etc.

As shown in FIG. 1, the electronic apparatus 1 includes a display module 2, a timing controller (display control device) 7, and a main body device 10. The display module 2 is electrically connected to the timing controller 7 via a flexible cable or the like, and the timing controller 7 is electrically connected to the main body device 10 via a flexible cable or the like. In the electronic apparatus 1 of the present embodiment, the main body device 10 outputs pictures via the timing controller 7 and the display module 2 for display. Note that besides pictures, the main body device 10 may also output any information such as still images and symbols for display.

The display module 2 includes a display panel (display element) 2a, a scanning line drive circuit (gate driver) 4, a signal line drive circuit (source driver) 5, and a common electrode drive circuit 6.

The display panel 2a includes a plurality of pixels arranged in a matrix manner. Further, the display panel 2a includes N (where N is a given integer) scanning signal lines G (gate lines) via which the plurality of pixels are selected and scanned in a line-sequential manner. Furthermore, the display panel 2a includes M (where M is a given integer) data signal lines S (source lines) via which a data signal is supplied to a single row of pixels included in a selected line. The scanning signal lines G and the data signal lines S intersect each other.

Note that the sign “G(n)” shown in FIG. 1 represents the nth (where n is an integer of 1 to not more than N) scanning signal line G. For example, the signs “G(1)”, “G(2)”, and “G(3)” represent the first, second, and third scanning signal lines G, respectively. Meanwhile, the sign “S(i)” represents the ith (where i is an integer of 1 to not more than M) data signal line S. For example, the signs “S(1)”, “S(2)”, and “S(3)” represent the first, second, and third data signal lines S, respectively.

The scanning line drive circuit 4 scans the scanning signal lines G of the display panel 2a in sequence, for example, from the scanning signal line G(1) toward the scanning signal line G(n). In so doing, the scanning line drive circuit 4 outputs, to each of the scanning signal lines G, a rectangular wave for turning on a switching element provided in each pixel and connected to a pixel electrode. This renders a single row of pixels of the display panel 2a selected.

Note, however, that the scanning in the scanning line drive circuit 4 is not to be limited to the aforementioned sequential scanning. For example, interlaced scanning may be carried out in which the odd-numbered scanning signal lines, namely the first, third, fifth,. . . scanning signal lines, are scanned first and then the even-numbered scanning signal lines, namely the second, fourth, sixth, . . . scanning signal lines, are scanned.

The signal line drive circuit 5 receives picture signals (indicated by Arrow A; image signals) from the main body device 10 via the timing controller 7, converts the picture signals into voltages that are to be outputted to pixels of a single selected row, and outputs the voltages to the data signal lines S, respectively, thereby supplying image data to pixels on a selected scanning signal line G.

Further, the display panel 2 includes a common electrode (not illustrated) provided for every pixel within the screen. The common electrode drive circuit 6 receives a polarity reversal signal (indicated by Arrow B) from the timing controller 7 and, in accordance with the polarity reversal signal, outputs to the common electrode a predetermined common voltage (indicated by Arrow C) by which the common electrode is driven.

The timing controller 7 receives picture signals from the main body device 10 (as indicated by Arrow A) and further receives clock signals and synchronizing signals, namely a horizontal synchronizing signal (Hsync) and a vertical synchronizing signal (Vsync), from the main body device 10 (as indicated by Arrow D). In accordance with these received signals, the timing controller 7 generates horizontal synchronizing control signals and vertical synchronizing control signals as picture synchronizing signals on the basis of which the circuits of the display module 2 operate in synchronization with each other, and then outputs these picture synchronizing signals to the scanning signal line drive circuit 4 and the signal line drive circuit 5 as needed (as indicated by Arrows E and F).

Specifically, the timing controller 7 outputs a gate start pulse signal, a gate clock signal, and a gate output enable signal to the scanning line drive circuit 4 (as indicated by Arrow E). Further, the timing controller 7 outputs a source start pulse signal, a source latch strobe signal, and a source clock signal to the signal line drive circuit 5 (as indicated by Arrow F), and also outputs picture signals to the signal line drive circuit 5 (as indicated by Arrow A).

The horizontal synchronizing control signal is used in the signal line drive circuit 5 as an output timing signal in accordance with which the timing of output of a picture signal to the display panel 2a is controlled, and is also used in the scanning signal drive circuit 4 as a timing signal in accordance with which the timing of output of a scanning signal to the display panel 2a is controlled. Further, the vertical synchronizing control signal is used in the scanning line drive circuit 4 as a timing signal in accordance with which the timing of the start of scanning of the scanning signal lines G is controlled.

The scanning line drive circuit 4 starts scanning of the display panel 2a in accordance with the horizontal and vertical synchronizing control signals from the timing controller 7, and the scanning line drive circuit 4 selects the scanning signal lines G in sequence and outputs a scanning signal to a selected scanning signal line G. Meanwhile, the signal line drive circuit 5 writes image data based on picture signals to the data signal lines S of the display panel 2a in accordance with the horizontal synchronizing control signal from the timing controller 7. Writing of the image data is achieved, for example, by a DAC (digital-to-analog converter) and a source amplifier circuit of the signal line drive circuit 5.

The example shown in FIG. 1 only shows a single scanning line drive circuit 4 and a single signal line drive circuit 5. However, this does not imply any limitation. The display module 2 may be mounted with a plurality of scanning line drive circuits 4 and a plurality of signal line drive circuits 5.

The main body device 10 serves to carry out main processes in the electronic apparatus 1, and is configured, for example, to include a CPU (central processing unit), a memory, etc. As shown in FIG. 1, the main body device 10 includes a display signal transfer section (display control device, image transferring means) 11 that transfers display signals such as picture signals, clock signals, vertical synchronizing signals, and horizontal synchronizing signals to the timing controller 7 so that the display panel 2a outputs pictures for display.

Note that the circuits in the electronic apparatus 1 are supplied by a power supply generation circuit (not illustrated) with voltage necessary for driving and operation of the circuits. In the example shown in FIG. 1, the signal line drive circuit 5 is supplied with a power supply voltage Vdd.

Note also that the scanning line drive circuit 4 and the signal line drive circuit 5 may sometimes be hereinafter collectively referred to as “drive circuits 4 and 5”.

In the present embodiment, as soon as the timing controller 7 starts receiving picture signals from the main body device 10, the timing controller 7 instructs the drive circuits 4 and 5 to start a process of scanning the display panel 2a. That is, upon receiving picture signals from the main body device 10, the timing controller 7 generates picture synchronizing signals in accordance with which the scanning process is executed, and then outputs these picture synchronizing signals to the drive circuits 4 and 5, as well as outputting the picture signals to the signal line drive circuit 5.

Further, as soon as the timing controller 7 stops receiving picture signals from the main body device 10, the timing controller 7 instructs the display module 2 to pause the process of scanning the display panel 2a, whereby when the reception of picture signals is stopped, the display module 2 is instructed to pause the scanning process, so that the process of scanning the display panel 2a is paused. For this reason, even with a change in intermittent operation, there is no change in condition for pausing and execution of the scanning process. This makes it possible to deal with various intermittent operations without inviting increases in scale and complexity of the circuit configuration.

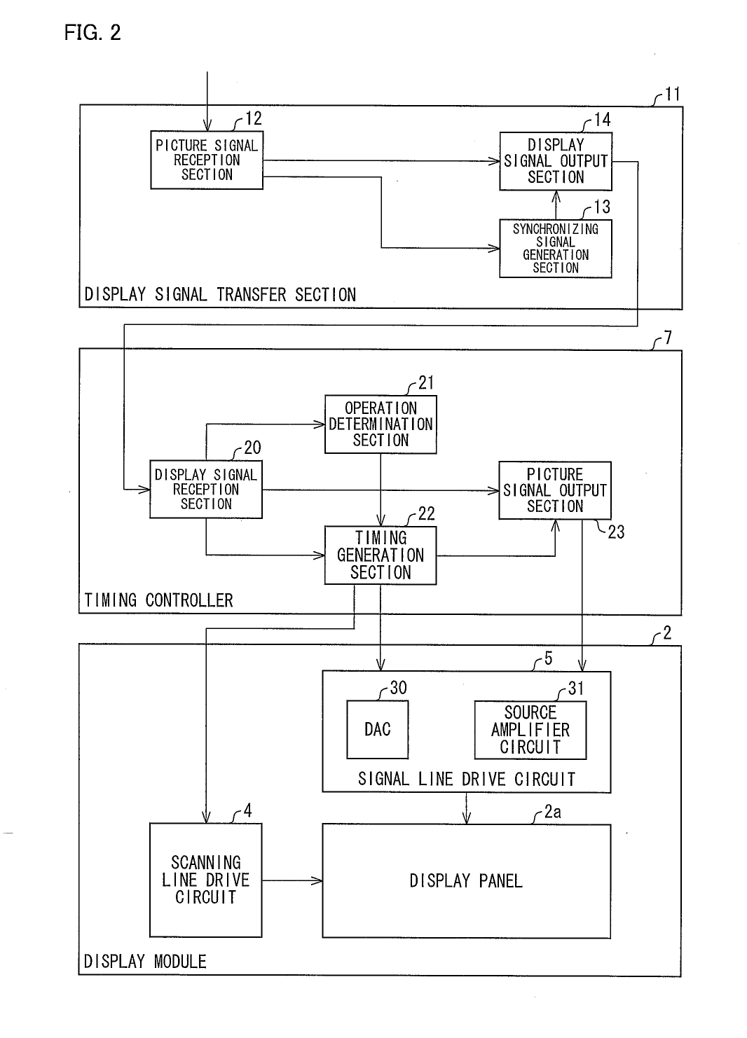

FIG. 2 is a block diagram showing details of configurations of the display signal transfer section 11 and the timing controller 7. As shown in FIG. 2, the display signal transfer section 11 is configured to include a picture signal reception section (image transferring means) 12, a synchronizing signal generation section 13, and a display signal output section (image transferring means) 14. Further, the timing controller 7 is configured to include a display signal reception section (image transferring means) 20, an operation determination section (drive instruction means) 21, a timing generation section (drive instruction means) 22, and a picture signal output section (image transferring means) 23.

The picture signal reception section 12 serves to receive picture signals, for example, from a frame memory (not illustrated) provided inside the main body device 10. The picture signal reception section 12 transmits received picture signals to the synchronizing signal generation section 13 and the display signal output section 14.

The synchronizing signal generation section 13 serves to generate vertical synchronizing signals and horizontal synchronizing signals in accordance with picture signals from the picture signal reception section 12 and clock signals from a clock oscillator (not illustrated) provided in the main body device 10. The synchronizing signal generation section 13 transmits vertical and horizontal synchronizing signals thus generated to the display signal output section 14. The display signal output section 14 outputs display signals, including picture signals from the picture signal reception section 12, vertical and horizontal synchronizing signals from the synchronizing signal generation section 13, and the clock signals, to the timing controller 7 in accordance with the clock signals.

The display signal reception section 20 serves to receive display signals, including picture signals, from the display signal transfer section 11. The display signal reception section 20 transmits the picture signals to the picture signal output section 23, among the received display signals, and transmits the remaining display signals, i.e., the clock signals, the vertical synchronizing signals, and the horizontal synchronizing signals, to the timing generation section 22. Furthermore, the display signal reception section 20 notifies the operation determination section 21 whether or not the display signal reception section 20 is receiving picture signals from the display signal transfer section 11.

The operation determination section 21 serves to determine, in accordance with notification from the display signal reception section 20, whether or not the operation of scan processing is executed. Specifically, while the display signal reception section 20 is receiving picture signals, the operation determination section 21 determines that the operation of scan processing should be executed, and while the display signal reception section 20 is receiving no picture signals, the operation determination section 21 determines that the operation of scan processing should be paused. The operation determination section 21 notifies the timing generation section 22 of a result of determination.

The timing generation section 22 generates, in accordance with display signals from the display signal reception section 20, various timing signals (vertical synchronizing control signals and horizontal synchronizing control signals) in accordance with which the timing of driving of the drive circuits 4 and 5 is controlled. The timing generation section 22 outputs timing signals thus generated to the picture signal output section 23 and the drive circuits 4 and 5.

Furthermore, the timing generation section 22 instructs the drive circuits 4 and 5 in accordance with a result of determination by the operation determination section 21 to execute or pause the scanning process in the display panel 2a. Specifically, in a case where the operation determination section 21 has determined that the scanning process should be executed, the timing generation section 22 instructs the drive circuits 4 and 5 to execute the scanning process. On the other hand, in a case where the operation determination section 21 has determined that the scanning process should be paused, the timing generation section 22 instructs the drive circuits 4 and 5 to pause the scanning process.

Upon being instructed by the timing generation section 22 to pause the scanning process, the scanning line drive circuit 4 stops scanning the scanning signal lines G of the display panel 2a. Meanwhile, upon being instructed by the timing generation section 22 to pause the scanning process, the signal line drive circuit 5 stops output to the data signal lines S. This causes the display panel 2a to stop being driven, so that the scanning process is paused. This results in a reduction in the amount of electric power that is consumed in the display panel 2a.

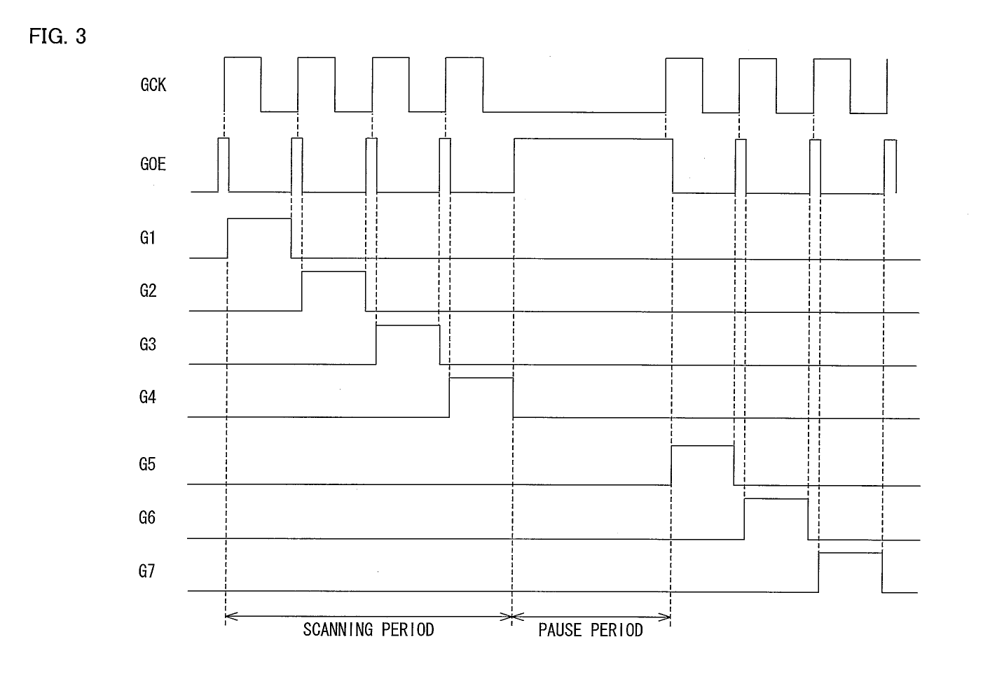

Note that although the instruction by the timing generation section 22 for the drive circuits 4 and 5 to execute or pause the scanning process may be given by separate signals from the timing signals, it is desirable that the instruction be given by utilizing the timing signals. This is described with reference to FIG. 3.

FIG. 3 is a timing chart showing examples of temporal changes in timing signals that are outputted to the scanning line drive circuit 4 and in output signals from the scanning line drive circuit 4. FIG. 3 shows temporal changes in a gate clock signal GCK, in a gate output enable signal GOE, and in scanning signals G1 to G7, beginning at the top.

The gate output enable signal GOE rises at a point in time where a predetermined period of time has elapsed since a fall in the gate clock signal GCK, and falls at a point in time where a predetermined period of time has elapsed since a rise in the gate clock signal GCK. When the gate output enable signal GOE rises, a scanning signal G currently at a H (high) level falls, and when the gate output enable signal GOE falls, a next scanning signal G rises. That is, while the gate output enable signal GOE is at a H level, all the scanning signals G are at a L (low) level, with the result that the driving is paused.

Accordingly, in a case where the operation determination section 21 has determined that the scanning process should be paused, the timing controller 7 keeps the gate clock signal GCK at a L level, and keeps the gate output enable signal GOE at a H level after the predetermined period of time has elapsed. As a result, the scanning signal lines G stop being scanned. From this, it can be understood that the instruction by the timing generation section 22 for the scanning line drive circuit 4 to execute or pause the scanning process can be achieved with the existing timing signals alone.

As for the signal line drive circuit 5, in a case where the operation determination section 21 has determined that the scanning process should be paused, the timing controller 7 needs only keep the source start pulse signal, the source latch strobe signal, and the source clock signal at a L level. In this case, the signal line drive circuit 5 stops the process of output to the data signal lines S. Therefore, the instruction by the timing generation section 22 for the signal line drive circuit 5 to execute or pause the scanning process can be achieved with the existing timing signals alone.

Referring again to FIG. 2, the picture signal output section 23 outputs picture signals from the display signal reception section 20 to the signal line drive circuit 5 in accordance with timing signals from the timing generation section 22. The picture signals thus outputted are outputted to the display panel 2a via the DAC 30 and the source amplifier circuit 31 of the signal line drive circuit 5.

In the foregoing configuration, as soon as the display signal reception section 20 receives picture signals from the display signal transfer section 11, the operation determination section 21 determines that the scanning process should be executed. This causes the timing generation section 22 to generate various timing signals and transmit them to the drive circuits 4 and 5 and to instruct the drive circuits 4 and 5 to execute the scanning process, and causes the picture signal output section 23 to output picture signals to the signal line drive circuit 5. As a result, the scanning process in the display panel 2a is carried out, and pictures based on the picture signals are displayed.

After that, when the display signal reception section 20 no longer receives the picture signals, the operation determination section 21 determines that the scanning process should be paused. This causes the timing generation section 22 to generate various timing signals and transmit them to the drive circuits 4 and 5 and to instruct the drive circuits 4 and 5 to pause the scanning process. Since the display signal reception section 20 is not receiving the picture signals, the output of the picture signals from the picture signal output section 23 to the signal line drive circuit 5 is of course stopped. As a result, the scanning process in the display panel 2a is paused, and the display panel 2a retains its display.

Then, as soon as the display signal reception section 20 resumes receiving the picture signals, the operation determination section 21 determines that the scanning process should be resumed. This causes the timing generation section 22 to generate various timing signals and transmit them to the drive circuits 4 and 5 and to instruct the drive circuits 4 and 5 to resume the scanning process, and causes the picture signal output section 23 to resume outputting picture signals to the signal line drive circuit 5. As a result, the scanning process in the display panel 2a is resumed, and pictures based on the picture signals are displayed.

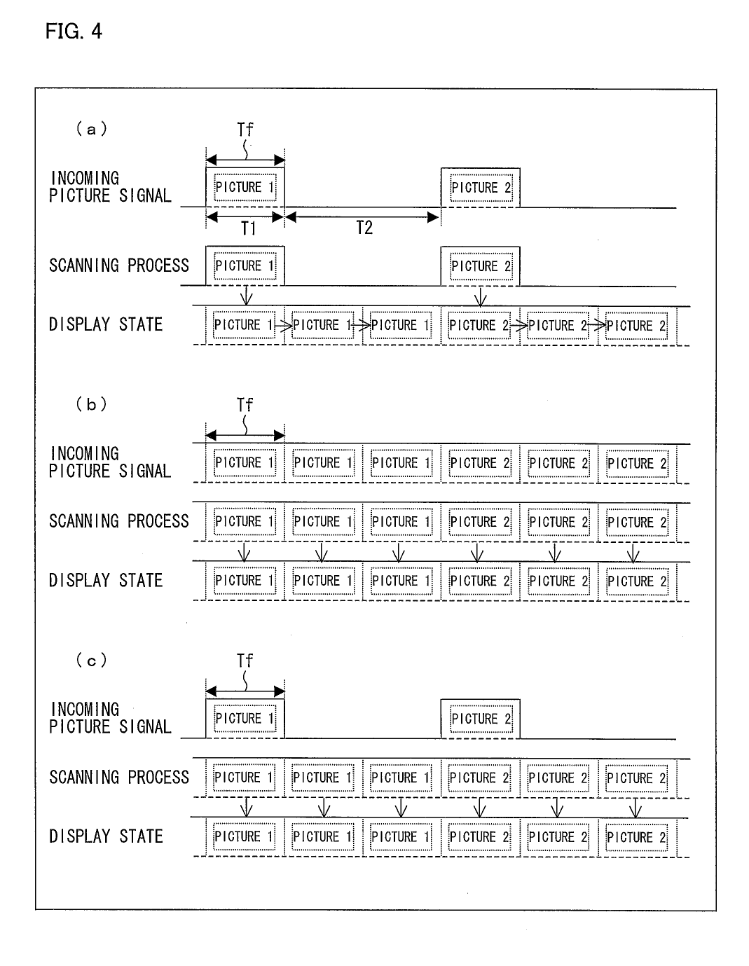

FIG. 4 is a set of timing charts showing examples of temporal changes in received picture signal (incoming picture signal), in scanning process, and in display state. (a) of FIG. 4 concerns the display module 2 of the present embodiment. Meanwhile, (b) of FIG. 4 shows a reference example concerning a conventional display module. Further, (c) of FIG. 4 shows a reference example concerning a conventional display module including a frame memory. In the following, a single frame period is referred to as “Tf”.

In the example shown in FIG. 4, PICTURE 1 is displayed for the duration of three frame periods 3Tf first, and then PICTURE 2 is displayed for the duration of three frame periods 3Tf. For ease of viewing, FIG. 4 shows INCOMING PICTURE SIGNAL, SCANNING PROCESS, and DISPLAY STATE with their timings aligned. However, in actuality, the timing of SCANNING PROCESS slightly lags the timing of INCOMING PICTURE SIGNAL, and the timing of DISPLAY STATE slightly lags the timing of SCANNING PROCESS.

As shown in (b) of FIG. 4, the conventional display module receives a picture signal, carries out a scanning process, and displays a picture, in each frame period Tf. This makes it necessary to receive the same picture signal for three consecutive frame periods 3Tf.

Meanwhile, the conventional display module including a frame memory reads out a picture signal from the frame memory, carries out a scanning process, and displays a picture, in each frame period Tf. Since this display module can retain a picture signal in the frame memory, it does not need to receive the same picture signal, as shown in (c) of FIG. 4.

On the other hand, as shown in (a) of FIG. 4, the display module 2 of the present embodiment carries out a scanning process on a picture signal only during a frame period Tf during which the picture signal is received. Specifically, during the first frame period, the display module 2 receives a signal of PICTURE 1, carries out a scanning process, and displays PICTURE 1. Moreover, during the second and third frame periods, the display module 2 does not receive picture signals and therefore pauses the scanning process. This causes PICTURE 1 to remain displayed. Moreover, during the fourth frame period, the display module 2 receives a signal of PICTURE 2 and therefore resumes the scanning process and displays PICTURE 2.

Referring to FIG. 4, the display module 2 of the present embodiment carries out the scanning process less frequently than the conventional display module and, as a result, can be found to consume less electric power.

The example shown in FIG. 4 assumes the scanning period T1, during which the scanning process is executed, corresponds to a single frame period Tf and the pause period T2, during which the scanning process is paused, corresponds to two frame periods 2Tf. However, this does not imply any limitation. The scanning period T1 varies depending on a period during which a picture signal is received, and the pause period T2 varies depending on a period during which no picture signal is received.

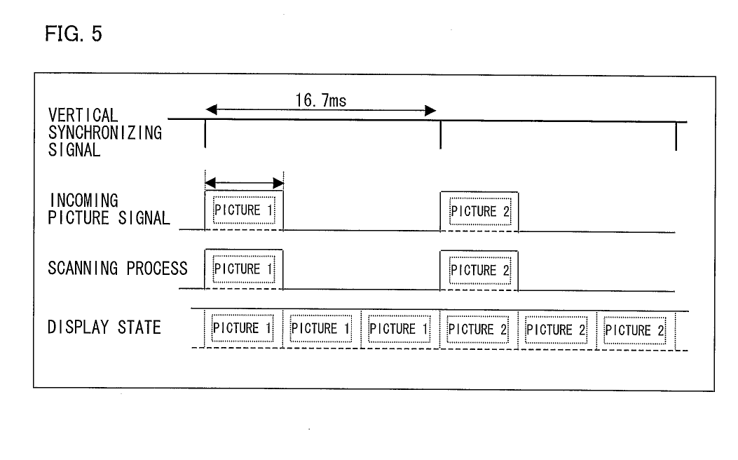

FIG. 5 is a timing chart showing other examples of temporal changes in incoming picture signal, in scanning process, and in display state. In the example illustrated, reception of a picture signal of a single frame and a scanning process are carried out in a period ⅓Tf that is one third of a single frame period ( 1/60≈16.7 ms), i.e., a period of a vertical synchronizing signal. In this case, the scanning period T1 is ⅓Tf, and the pause period T2 is ⅔Tf.

In the present embodiment, the display module 2 and the timing controller 7 are formed separately from each other. Alternatively, the display module 2 and the timing controller 7 may be formed integrally with each other. In this case, the signal line drive circuit 5 of the display module 2 may function as the timing controller 7.

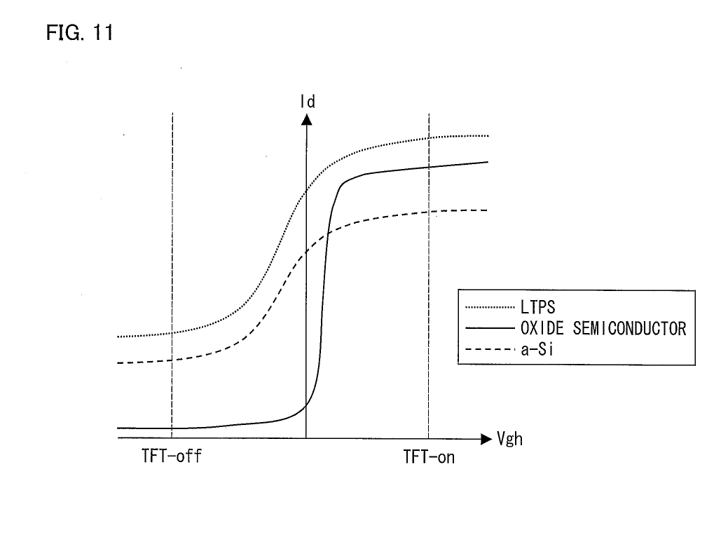

Further, in the present embodiment, a TFT (thin-film transistor) whose semiconductor layer is made of a so-called oxide semiconductor is employed as a switching element in each of the pixels of the display panel 2a. Examples of the oxide semiconductor include IGZO (InGaZnOx). An advantage of this feature is described with reference to FIG. 11.

FIG. 11 is a graph showing the characteristics of various TFTs. FIG. 11 shows the respective characteristics of a TFT fabricated from an oxide semiconductor, a TFT fabricated from a-Si (amorphous silicon), and a TFT fabricated from LTPS (low-temperature polysilicon). In FIG. 11, the horizontal axis represents the gate voltage Vgh, and the vertical axis represents the drain current Id.

As shown in FIG. 11, in a case where the gate voltage Vgh is equal to or less than a threshold value Vth, the TFTs are in an off-state in which the drain current Id is small and substantially constant. Next, when the gate voltage Vgh rises and exceeds the threshold value Vth, the drain current Id rises. Then, when the gate voltage Vgh further rises and exceeds a value Vgh (TFT-on), the TFTs are in an on-state in which the drain current Id is large and substantially constant.

Furthermore, as shown in FIG. 11, the oxide semiconductor TFT is larger in electric current (i.e., electron mobility) in the on-state than the a-Si TFT. Specifically, although not illustrated, whereas the drain current Id of the a-Si TFT at the gate voltage Vgh (TFT-on) was 1 μA, the drain current Id of the oxide semiconductor TFT at the gate voltage Vgh (TFT-on) ranged from approximately 20 to 50 μA. It can be understood from this that the oxide semiconductor TFT is 20 to 50 times higher in electron mobility in the on-state than the a-Si TFT and therefore has excellent on-characteristics.

Further, as shown in FIG. 11, the oxide semiconductor TFT is smaller in electric current (i.e., leak current) in the off-state than the a-Si TFT and the LTPS TFT. Specifically, although not illustrated, whereas the drain current Id of the a-Si TFT at the gate voltage Vgh (TFT-off), which is lower than the threshold value Vth, was 10 pA, the drain current Id of the oxide semiconductor TFT at the gate voltage Vgh (TFT-off) was approximately 0.1 pA. It can be understood from this that the leak current of the oxide semiconductor TFT in the off-state is about one hundredth of that of the a-Si TFT, hardly causes a leak current, and therefore has excellent off-characteristics.

For the reasons stated above, the employment of a TFT whose semiconductor layer is made of an oxide semiconductor as a switching element of each of the pixels in the display module 2 of the present embodiment allows the TFT of each of the pixels to have excellent on-characteristics and off-characteristics. This makes it possible to increase the amount of electron mobility with which pixel data is written to the pixels and shorten the amount of time required for the writing.

That is, since the display module 2 of the present embodiment can carry out scanning at a remarkably high speed and therefore shorten the scanning period T1, it can extend the pause period T2 accordingly. This makes it possible to further reduce the amount of electric power that is consumed in the display module 2.

### Embodiment 2

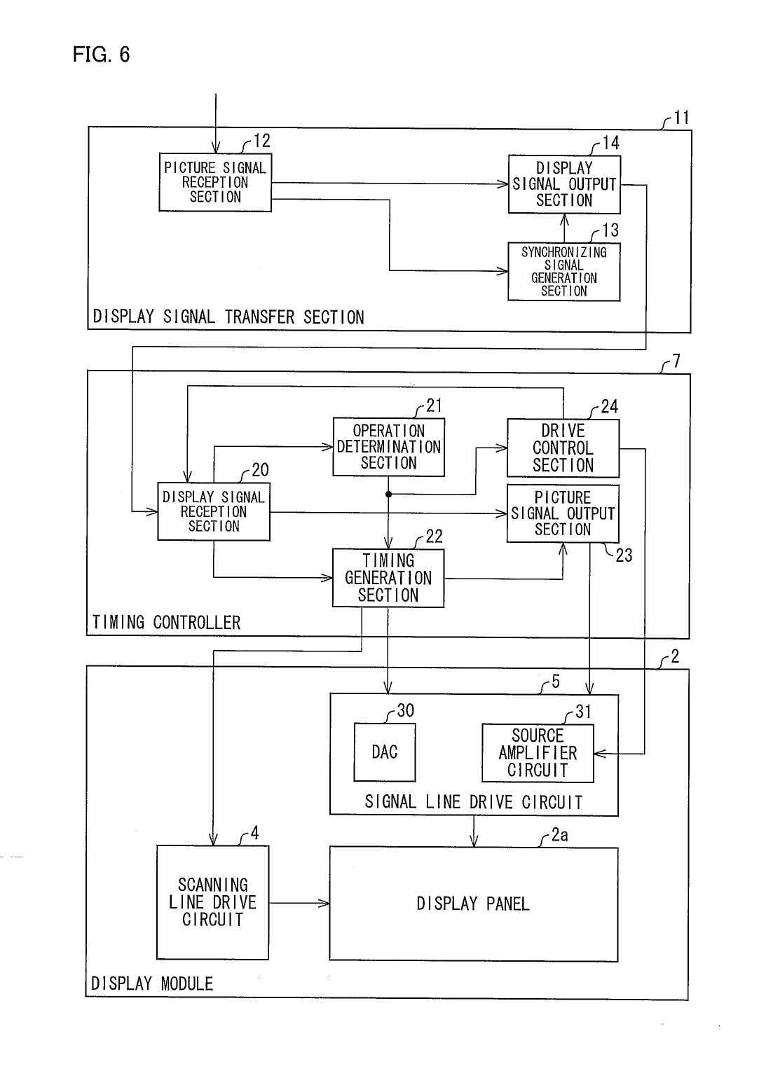

Next, another embodiment of the present invention is described with reference to FIG. 6. FIG. 6 is a block diagram showing details of configurations of a display signal transfer section 11 and a timing controller 7 in an electronic apparatus 1 according to the present embodiment.

The electronic apparatus 1 of the present embodiment is identical in configuration to the electronic apparatus 1 shown in FIG. 2, except that the timing controller 7 further includes a drive control section 24. Components and processes identical to those described in the above embodiment are given the same reference signs, and as such, are not described below.

The drive control section 24 serves to control, in accordance with a result of determination from the operation determination section 21, how the various circuits in the display module 2 are driven. Specifically, upon receiving a result of determination telling that the scanning process should be paused, the drive control section 24 controls the display signal reception section 20 and the source amplifier circuit 31 so that the display signal reception section 20 and the source amplifier circuit 31 are less driven or stop being driven. Meanwhile, upon receiving a result of determination telling that the scanning process should be executed, the drive control section 24 controls the display signal reception section 20 and the source amplifier circuit 31 so that the display signal reception section 20 and the source amplifier circuit 31 are driven in the way they were originally driven. This makes it possible to reduce the amount of electric power that is consumed by the timing controller 7 and the display module 2 during a pause period during which the scanning process is paused.

In the example illustrated, the display signal reception section 20 and the source amplifier circuit 31 are controlled in such a manner as to be less driven or to stop being driven. Alternatively, the other circuits may be less driven or stop being driven. Examples of how to less drive the circuits or to stop driving the circuits include reducing or zeroing the application voltage, reducing or zeroing the stationary electric current, reducing or zeroing the supply power, etc. Further, a period during which the circuits are less driven or stop being driven may be the same in length as a pause period, or may be a portion of a pause period.

### Embodiment 3

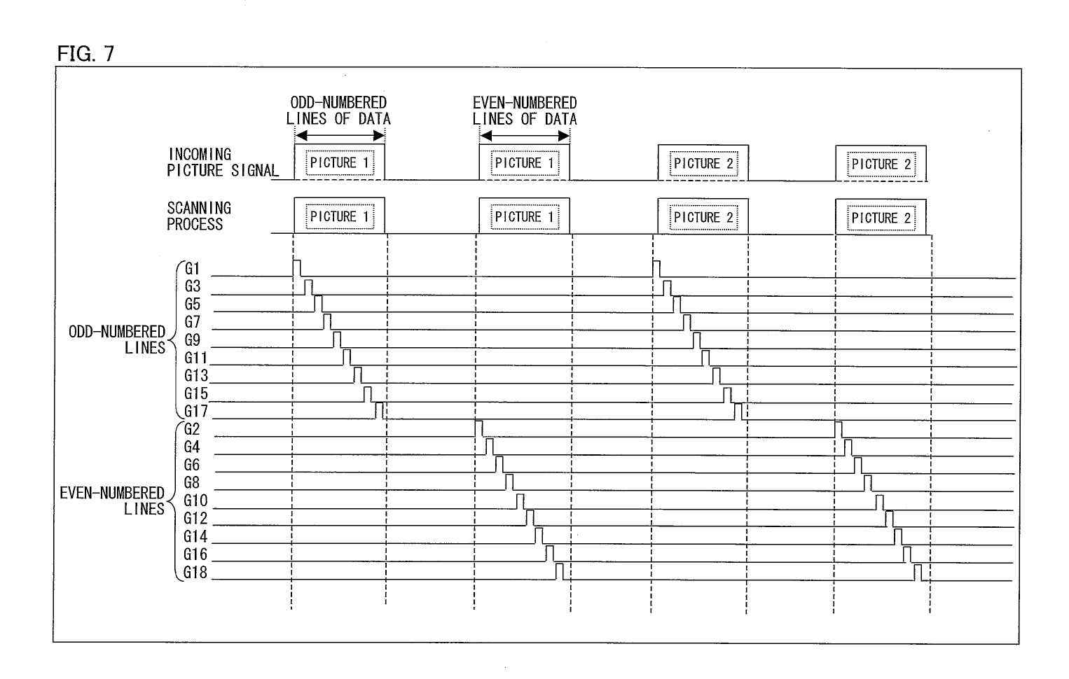

Next, still another embodiment of the present invention is described with reference to FIG. 7. The electronic apparatus 1 of the present embodiment is identical in configuration to the electronic apparatus 1 shown in FIGS. 1 through 5, except that the display module 2 is scanning by interlaced scanning. Components and processes identical to those described in the above embodiment are given the same reference signs, and as such, are not described below.

FIG. 7 is a timing chart showing temporal changes in operating state and various signals of the display module 2 of the present embodiment. FIG. 7 shows incoming picture signals, a scanning process, operation determination signals, and scanning signals that are outputted to the scanning signal lines G, beginning at the top.

Referring to FIG. 7, first, as soon as the display signal reception section 20 receives picture signals representing odd-numbered lines of PICTURE 1, the scanning process is started. At this time, the odd-numbered scanning signal lines G1, G3, G5, . . . are driven in sequence, so that a half of the frame is scanned. Next, the display signal reception section 20 stops receiving picture signals, whereby the scanning process is paused.

Next, first, as soon as the display signal reception section 20 receives picture signals representing even-numbered lines of PICTURE 1, the scanning process is started. At this time, the even-numbered scanning signal lines G2, G4, G6, . . . are driven in sequence, so that the remaining half of the frame is scanned. Next, the display signal reception section 20 stops receiving picture signals, whereby the scanning process is paused. After that, the same operation is repeated for the next PICTURE 2.

Thus, the electronic apparatus 1 of the present embodiment can pause the scanning process without setting timings in advance even in the case of an intermittent operation where a pause period is provided between scanning of part of a frame and scanning of a remaining part of the frame. In present embodiment, interlaced scanning is carried out every other scanning signal line G. Alternatively, interlaced scanning may be carried out every other plurality of scanning signal lines G.

### Embodiment 4

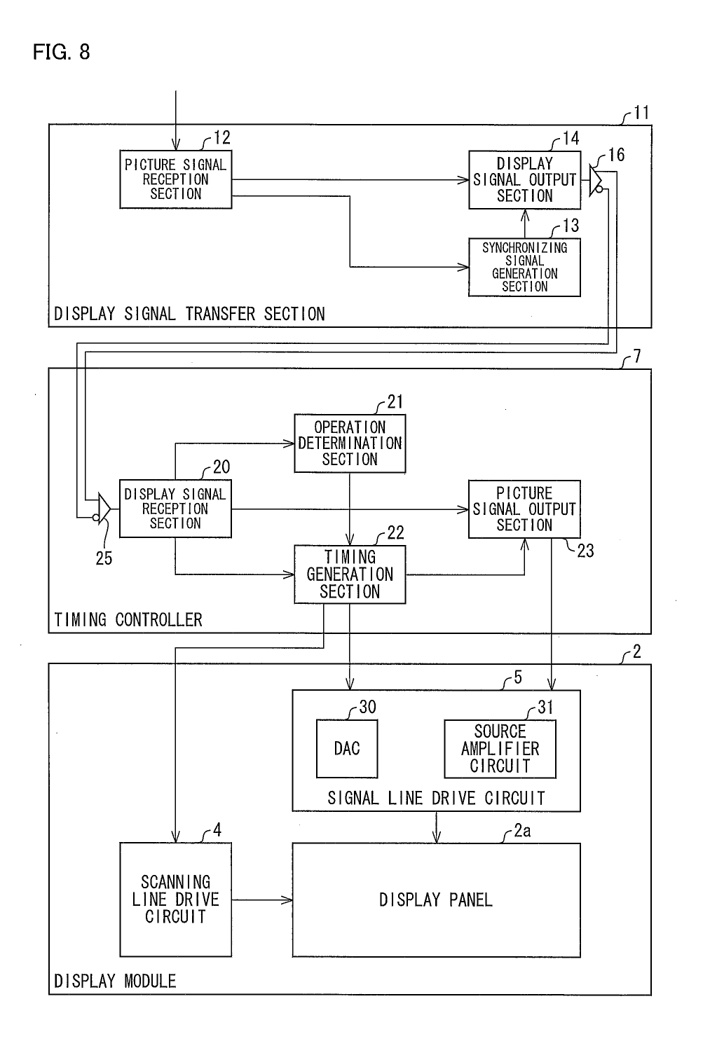

Next, still another embodiment of the present invention is described with reference to FIG. 8. FIG. 8 is a block diagram showing details of configurations of a display signal transfer section 11 and a timing controller 7 in an electronic apparatus 1 according to the present embodiment. The electronic apparatus 1 of the present embodiment is identical in configuration to the electronic apparatus 1 shown in FIGS. 1 through 5, except that the display signals that are outputted from the display signal transfer section 11 to the display signal reception section 20 are differential signals. Components and processes identical to those described in the above embodiment are given the same reference signs, and as such, are not described below.

The display signal transfer section 11 shown in FIG. 8 is identical in configuration to the display signal transfer section 11 shown in FIG. 2, except that the former further includes a transmitting-end differential amplifier 16 which converts display signals from the display signal output section 14 into differential signals. The transmitting-end differential amplifier 16 outputs the differential signals to the timing controller 7.

Further, the timing controller 7 shown in FIG. 8 is identical in configuration to the timing controller 7 shown in FIG. 2, except that the former includes a receiving-end differential amplifier 25 which converts differential signals from the display signal transfer section 11 into display signals. The receiving-end differential amplifier 25 transmits the display signals to the display signal reception section 20.

A differential signal is composed of a pair of signals, namely a positive signal and a negative signal, and the positive signal and the negative signal differ in phase from each other by substantially 180 degrees. A potential difference between these two signals serves as a signal level.

Use of a differential signal can make signal amplitude smaller than that of a single-ended signal, thus making it possible to increase the data transmission speed. Further, a differential signal brings about an advantageous effect of being resistant to common mode noise.

### Embodiment 5

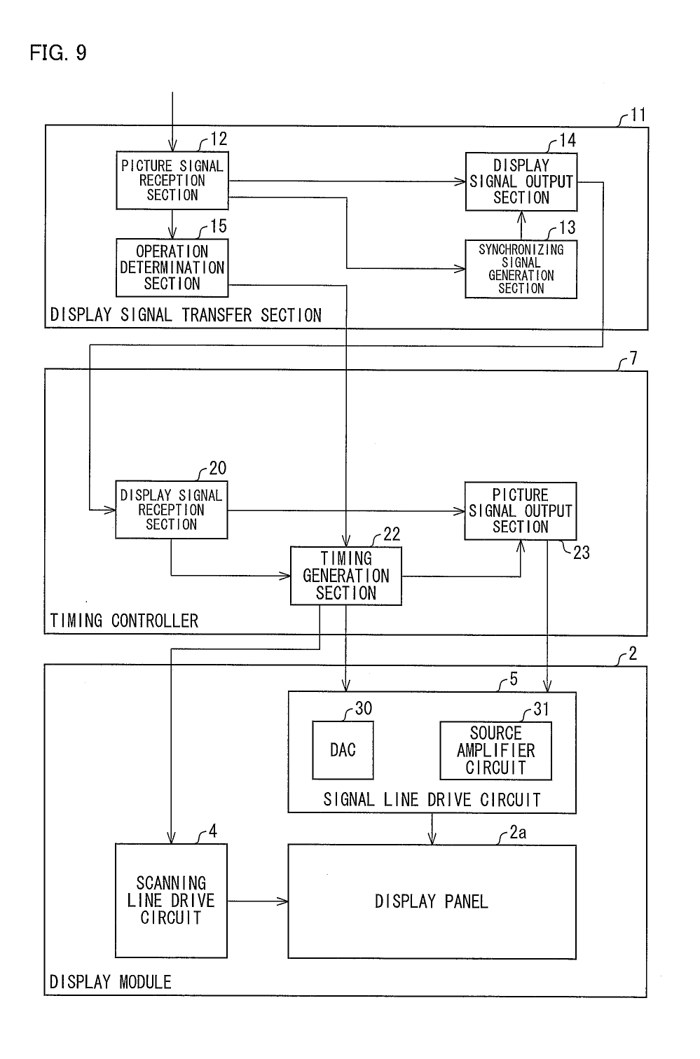

Next, still another embodiment of the present invention is described with reference to FIG. 9. FIG. 9 is a block diagram showing details of configurations of a display signal transfer section 11 and a timing controller 7 in an electronic apparatus 1 according to the present embodiment.

The electronic apparatus 1 of the present embodiment is identical in configuration to the electronic apparatus 1 shown in FIGS. 1 through 5, except that an operation determination section (drive instruction means) 15 is provided in the display signal transfer section 11 instead of the operation determination section 21 of the timing controller 7. Components and processes identical to those described in the above embodiment are given the same reference signs, and as such, are not described below.

The operation determination section 15 serves to determine, in accordance with picture signals from the picture signal reception section 12, whether or not the operation of scan processing in the display panel 2a is executed. Specifically, while the picture signal reception section 12 is receiving picture signals, the operation determination section 15 determines that the operation of scan processing should be executed, and while the picture signal reception section 12 is receiving no picture signals, the operation determination section 15 determines that the operation of scan processing should be paused. The operation determination section 15 outputs an operation determination signal indicative of a result of determination to the timing generation section 22.

Thus, the operation determination by which whether or not the scanning process is executed is determined in accordance with the presence or absence of picture signals received can be carried out by the timing controller 7, or can be carried out by the display signal transfer section 11. In a case where the operation determination is carried out by the display signal transfer section 11, the configuration of the timing controller 7 can be simplified.

Note that an operation determination signal may be outputted to the timing controller 7 in combination with any of the display signals, or may be outputted to the timing controller 7 via a separate signal line separately from the display signals.

Further, the operation determination section 15 may cause the various circuits in the display signal transfer section 11 to be less driven or stop being driven. This makes it possible to reduce the amount of electric power that is consumed by the display signal transfer section 11 during a pause period.

### Embodiment 6

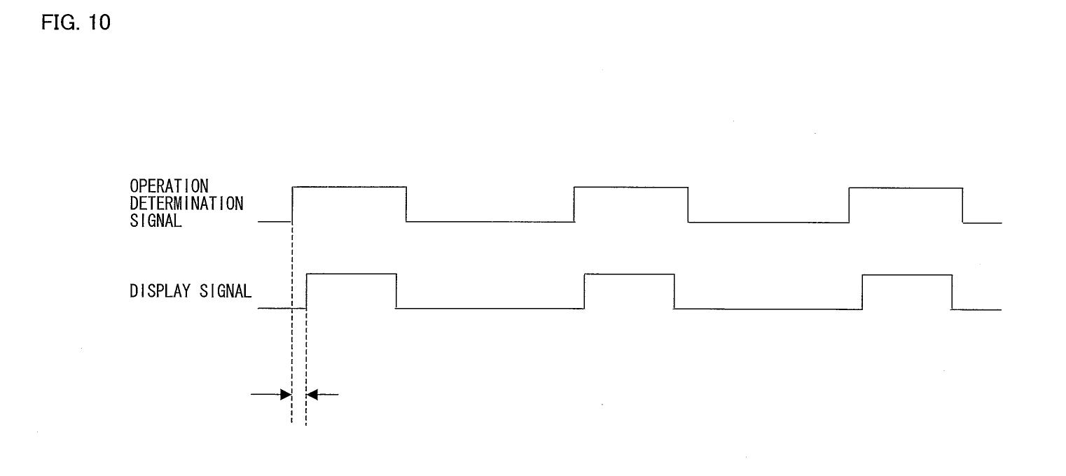

Next, still another embodiment of the present invention is described with reference to FIG. 10. The electronic apparatus 1 of the present embodiment is identical to the electronic apparatus 1 shown in FIG. 9, except that the display signal transfer section 11 outputs an operation determination signal and a display signal at different timings. Components and processes identical to those described in the above embodiment are given the same reference signs, and as such, are not described below.

FIG. 10 is a timing chart showing temporal changes in an operation determination signal and a display signal that are outputted by the display signal transfer section 11 of the electronic apparatus 1 of the present embodiment. In the example illustrated, when at a H level, the operation determination signal indicates that the operation of scan processing should be executed, and when at a L level, the operation determination signal indicates that the operation of scan processing should be paused. Further, when at a H level, the display signal is outputted, when at a L level, the display signal stops being outputted.

In the present embodiment, as shown in FIG. 10, in the case of transition of the operation determination signal from a L level (at which the scanning process is paused) to a H level (at which the scanning process is executed), the operation determination signal is outputted before the display signal is outputted. Since this allows time for the display signal reception section 20 and the source amplifier circuit 31 to resume being driven, the display module 2 can avoid failure to receive the display signal or execute the scanning process.

Further, in the present embodiment, as shown in FIG. 10, in the case of transition of the operation determination signal from a H level (at which the scanning process is executed) to a L level (at which the scanning process is paused), the operation determination signal is outputted after the display signal is outputted. Since this allows the display signal reception section 20 and the source amplifier circuit 31 to stop being driven after completion of the scanning process based on the display signal outputted, the display module 2 can avoid failure to receive the display signal or execute the scanning process.

The present invention is not limited to the description of the embodiments above, but may be altered by a skilled person within the scope of the claims. An embodiment based on a proper combination of technical means disclosed in different embodiments is encompassed in the technical scope of the present invention.

For example, the display panel 2a according to the embodiment may be a liquid crystal panel including a liquid crystal layer. In this case, the display module 2 according to the embodiment is a liquid crystal display module.

Alternatively, each of the pixels of the display panel 2a according to the embodiment may have an organic EL (electroluminescence) diode, which is an element that emits light at a luminance corresponding to an electric current flowing therethrough. In this case, the display module 2 according to the embodiment is an organic EL display (organic electroluminescence display module). Since an organic EL display consumes a large electric current during a scanning process, a reduction in consumption current can be effectively achieved by applying the present invention.

Further, the timing controller 7 may include a frame buffer in which received picture signals are temporarily stored. In this case, even without the display signal reception section 20 receiving picture signals, the picture signal output section 23 reads out the picture signals from the frame buffer and output them to the display module 2.

Accordingly, the operation determination section 21 may be configured such that in a case where the picture signal output section 23 is outputting picture signals to the display module 2, the operation determination section 21 determines that the scanning process should be executed; meanwhile, in a case where the picture signal output section 23 is outputting no picture signals to the display module 2, the operation determination section 21 determines that the scanning process should be paused and notifies the timing generation section 22 accordingly. In so doing, while the scanning process in the display module 2 is paused when the output of picture signals to the display module 2 is stopped, the scanning process in the display module 2 is resumed when the output of picture signals to the display module 2 is resumed.

Further, in a case where the period from stoppage of reception of picture signals to resumption of reception of picture signals is short, the circuits may take long to get driven, so that resumption of the scanning process might be late. Accordingly, in a case where the scanning process is resumed within a predetermined period of time (e.g., 1 ms) after the reception of picture signal is stopped, it is preferable not to instruct the display module 2 to pause the scanning process. In this case, the operation of scan processing is continued. This makes it possible to avoid such a problem that resumption of the scanning process is late. Further, this makes it possible to exclude a short pause period such as a conventional flyback period.

As described above, in order to attain the foregoing object, a display control device according to the present invention is a display control device that controls a display module which carries out a scanning process to display an image based on an image signal received, in stopping transfer of the image signal to the display module, the display control device instructing the display module to pause the scanning process.

Further, in order to attain the foregoing object, a control method in which a display control device carries out control according to the present invention is a control method in which a display control device controls a display module which carries out a scanning process to display an image based on an image signal received, the control method including the step of, in stopping transfer of the image signal to the display module, instructing the display module to pause the scanning process.

According to the foregoing configuration and the method, when the transfer of received picture signals to the display module has been stopped, the display module is instructed to pause the scanning process so that the scanning process in the display module is paused. For this reason, there is no change in condition for pausing of the scanning process even if there is a change in intermittent operation. This makes it possible to deal with various intermittent operations without inviting increases in scale and complexity of a circuit configuration.

In a case where the display control device includes a frame buffer, an image signal received by the display control device is temporarily written to the frame buffer, read out from the frame buffer, and transferred to the display module. On the other hand, in a case where the display control device does not include a frame buffer, an image signal received by the display control device is immediately transferred to the display module. In this case, when the image signal is no longer received, the transfer of the image signal to the display module is stopped. That is, a case where the transfer of the image signal to the display module is stopped is a case where the image signal is no longer received. Therefore, when the image signal is no longer received, the display module may be instructed to pause the scanning process.

In an aspect of the present invention, the display control device is preferably configured such that when the transfer of the image signal to the display module is executed, the display module is instructed to execute the scanning process. In this case, there is no change in condition for executing of the scanning process even if there is a change in intermittent operation. This makes it possible to surely deal with various intermittent operations without inviting increases in scale and complexity of a circuit configuration.

Incidentally, a general circuit requires a certain amount of time between a point in time at which it is instructed to start processing and a point in time at which it is ready to start processing. Therefore, in an aspect of the present invention, the display control device is preferably configured such that after the display module has been instructed to start the scanning process, the transfer of the image signal is started. This allows the display module to start, without delay, the scanning process based on the image signal transferred.

In an aspect of the present invention, the display control device is preferably configured such that when the transfer of the image signal is stopped, an amount of electric power that is consumed by at least some of circuits contained in the display control device or in the display module is reduced. This makes it possible to reduce the amount of electric power that is consumed by the display control device or the display module during a pause period of the scanning process. Note that the amount of electric power that is consumed by a circuit can be reduced, for example, by stopping operation of the circuit.

In an aspect of the present invention, the display control device is preferably configured such that after a predetermined period of time has elapsed since transfer of a first image signal corresponding to an image of a portion of a single frame, a second image signal corresponding to an image of a remaining portion of the frame is transferred. Thus, it is possible to execute and pause the scanning process even in a case where a pause period is provided during the transfer of an image signal of a single frame.

It is preferable that the first and second image signals be interlaced image signals. In this case, the entire screen is roughly scanned, so that deterioration in display quality can be better suppressed, as compared with a case where one part of the screen and another part of the screen are scanned at a time interval.

In an aspect of the present invention, the display control device is preferably configured such that the image signal is transferred as a differential signal. In this case, resistance to noise is improved, so a transfer error can be suppressed.

As mentioned above, a general circuit requires a certain amount of time between a point in time at which it is instructed to start processing and a point in time at which it is ready to start processing. For this reason, in a case where the period from stoppage of reception of image signals to resumption of reception of image signals is short, resumption of the scanning process might be delayed. Therefore, in an aspect of the present invention, the display control device is preferably configured such that in a case where the transfer of the image signal is resumed within a predetermined period of time after the transfer of the image signal is stopped, the display module is not instructed to pause the scanning process. In this case, the operation of scan processing is continued, so a delay in the scanning process can be prevented.

In an aspect of the present invention, the display control device may be configured to include: image transfer means for transferring, to the display module, the image signal received; and drive instruction means for instructing the display module to start or pause the scanning process, the image transfer means for preparing state information indicative of whether or not the image signal is transferred to the display module and for transmitting the state information to the drive instruction means, the drive instruction means instructs the display module, in accordance with the state information received from the image transfer means, to start or pause the scanning process.

Note that an effect which is similar to the aforementioned effect can be brought about by a display system including: a display module which carries out a scanning process to display an image based on an image signal with a display element; and a display control device of the foregoing configuration which controls the display module.

In general, a display module includes an output circuit which outputs, to the display element, an image signal received, and the output circuit consumes more electric power than the other circuits contained in the display module. Therefore, in an aspect of the present invention, the display system is more preferably configured such that in stopping transfer of the image signal, the display control device instructs the display module to reduce an amount of electric power that is consumed by the output circuit. This makes it possible to effectively reduce the amount of electric power that is consumed by the display module during a pause period of the scanning process.

Note that the display module and the display control device may be integrated with each other or may be separate from each other. In a case where they are separate from each other, they need only be electrically connected via a flexible cable or the like.

Note that examples of the display module include a liquid crystal display module, an organic electroluminescence (EL) display module, etc. Since an organic EL display module consumes a large electric current during a scanning mode, a reduction in consumption current can be effectively achieved by applying the present invention.

In an aspect of the present invention, the display system is preferable configured such that: the display element includes a plurality of pixels and a plurality of switching elements provided in the plurality of pixels, respectively; and each of the switching elements is a TFT whose semiconductor layer is made of an oxide semiconductor.

By employing, as the switching element of each pixel, a TFT whose semiconductor layer is made of an oxide semiconductor that is comparatively high in the amount of electron mobility, the amount of electron mobility with which image data is written to each pixel is increased, so the amount of time required for the writing can be shortened. This makes it possible to carry out scanning at a remarkably high speed and shorten a scanning period during which the scanning process is executed, thereby accordingly extending a pause period during which the scanning process is paused. This makes it possible to further improve a reduction in the amount of electric power that is consumed in the display module. Note that it is preferable to use IGZO, which is higher in the amount of electron mobility, as the oxide semiconductor.

### INDUSTRIAL APPLICABILITY

As described above, a display control device according to the present invention is configured such that when the transfer of received picture signals to the display module has been stopped, the display module is instructed to pause the scanning process so that the scanning process in the display module is paused. As such, the display control device is capable of dealing with various intermittent operations without inviting increases in scale and complexity of a circuit configuration, and is therefore applicable to any display module that carries out scanning.

### REFERENCE SIGNS LIST

1 Electronic apparatus (display system)

2 Display module

2a Display panel (display element)

4 Scanning line drive circuit

5 Signal line drive circuit

6 Common electrode drive circuit

7 Timing controller (display control device)

10 Main body device

11 Display signal transfer section (display control device, image transferring means)

12 Picture signal reception section (image transferring means)

13 Synchronizing signal generation section

14 Display signal output section (image transferring means)

15 Operation determination section (drive instruction means)

16 Transmitting-end differential amplifier

20 Display signal reception section (image transferring means)

21 Operation determination section (drive instruction means)

22 Timing generation section (drive instruction means)

23 Picture signal output section (image transferring means)

24 Drive control section

25 Receiving-end differential amplifier

30 DAC

31 Source amplifier circuit

1-18. (canceled)

19. A display control device that controls a display module which carries out a scanning process to display an image based on an image signal received,
in stopping transfer of the image signal to the display module, the display control device instructing the display module to pause the scanning process.

20. The display control device as set forth in claim 19, wherein a case where the transfer of the image signal to the display module is stopped is a case where the image signal is no longer received.

21. The display control device as set forth in claim 19, wherein when the transfer of the image signal to the display module is executed, the display module is instructed to execute the scanning process.

22. The display control device as set forth in claim 21, wherein after the display module has been instructed to start the scanning process, the transfer of the image signal is started.

23. The display control device as set forth in claim 19, wherein when the transfer of the image signal is stopped, an amount of electric power that is consumed by at least some of circuits contained in the display control device or in the display module is reduced.

24. The display control device as set forth in claim 19, wherein after a predetermined period of time has elapsed since transfer of a first image signal corresponding to an image of a portion of a single frame, a second image signal corresponding to an image of a remaining portion of the frame is transferred.

25. The display control device as set forth in claim 24, wherein the first and second image signals are interlaced image signals.

26. The display control device as set forth in claim 19, wherein the image signal is transferred as a differential signal.

27. The display control device as set forth in claim 19, wherein in a case where the transfer of the image signal is resumed within a predetermined period of time after the transfer of the image signal is stopped, the display module is not instructed to pause the scanning process.

28. The display control device as set forth in claim 19, comprising:
image transfer section for transferring, to the display module, the image signal received; and
drive instruction section for instructing the display module to start or pause the scanning process,
the image transfer section for preparing state information indicative of whether or not the image signal is transferred to the display module and for transmitting the state information to the drive instruction section,
the drive instruction section instructs the display module, in accordance with the state information received from the image transfer section, to start or pause the scanning process.

29. A display system comprising:
a display module which carries out a scanning process to display an image based on an image signal with a display element; and
a display control device as set forth in claim 19 which controls the display module.

30. The display system as set forth in claim 29, wherein:
the display module includes an output circuit which outputs, to the display element, an image signal received; and
in stopping transfer of the image signal, the display control device instructs the display module to reduce an amount of electric power that is consumed by the output circuit.

31. The display system as set forth in claim 29, wherein the display module and the display control device are separate from each other.

32. The display system as set forth in claim 29, wherein the display module is a liquid crystal display module.

33. The display system as set forth in claim 29, wherein the display module is an organic electroluminescence display module.

34. The display system as set forth in claim 29, wherein:
the display element includes a plurality of pixels and a plurality of switching elements provided in the plurality of pixels, respectively; and
each of the switching elements is a TFT whose semiconductor layer is made of an oxide semiconductor.

35. The display system as set forth in claim 34, wherein the oxide semiconductor is IGZO.

36. A control method in which a display control device controls a display module which carries out a scanning process to display an image based on an image signal received,
the control method comprising the step of, in stopping transfer of the image signal to the display module, instructing the display module to pause the scanning process.
